(19) United States
(12) Patent Application Publication
(10) Pub. No.: US 2022/0385734 A1
(43) Pub. Date: Dec. 1, 2022

(54) INTEGRATED MOBILE EDGE COMPUTE AND STORAGE PLATFORM

(71) Applicant: Kymeta Corporation, Redmond, WA (US)

(72) Inventors: Benjamin Posthuma, Gig Harbor, WA (US); David Fotheringham, Seattle, WA (US); Luis Varela, Kirkland, WA (US)

(21) Appl. No.: 17/748,506

(22) Filed: May 19, 2022

Related U.S. Application Data
(60) Provisional application No. 63/194,467, filed on May 28, 2021.

(51) Int. Cl. H04L 67/51; H04L 67/12; B64C 39/02

(52) U.S. Cl. CPC H04L 67/51; H04L 67/12; B64C 39/024; B64C 2201/122

(57) ABSTRACT

A mobile communications terminal with an integrated mobile compute platform and method for using the same are described. In some embodiments, the mobile communications terminal comprises: one or more communication interfaces for connecting to the terminal; and a compute platform to request and execute one or more context-based software components automatically based on each connection made to the platform.

### RELATED APPLICATION

The present application is a non-provisional application of and claims the benefit of U.S. Provisional Patent Application No. 63/194,467, filed May 28, 2021 and entitled “Integrated Mobile Edge Compute and Storage Platform,” which is incorporated by reference in its entirety.

### FIELD OF THE INVENTION

Embodiments disclosed herein are related to wireless communications; more particularly, embodiments disclosed herein are related to mobile communications units having integrated edge platforms.

### BACKGROUND

Edge computing and storage platforms associated with them are a distributed computing paradigm that brings data and its processing closer to the data sources. In comparison to cloud computing, edge computing is the computation and real-time processing of real-time data at the edge of the network, and more specifically in applications where real-time processing of data is required.

There are a number of reasons edge computing is considered advantageous over cloud computing platforms. These include the cost of moving data from the edge to the cloud for processing is too high, the latency of moving data from the edge to the cloud for processing is too long, the value of the data captured at the edge may not be worth moving to the cloud and processing locally to optimize value will ensure the cost is not too high, and line of sight (satellite) communications do not always have a data session available.

Even with these advantages, current edge computing paradigms are limited to discrete, stationary environments.

### SUMMARY

A mobile communications terminal with an integrated mobile compute platform and method for using the same are described. In some embodiments, the mobile communications terminal comprises: one or more communication interfaces for connecting to the terminal; and a compute platform to request and execute one or more context-based software components automatically based on each connection made to the platform.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram of some embodiments of a mobile communications terminal.

FIG. 2 illustrates some other embodiments of a mobile communications terminal with a compute and storage platform.

FIG. 3 is a flow diagram of some embodiments of a process for processing data with a compute and storage platform on a mobile communications terminal.

FIG. 4 is a flow diagram of some embodiments of a process for executing microservices responsive to a connection to a mobile communications terminal.

FIG. 5 illustrates some embodiments of a computing device that may be part of the mobile communications terminal.

FIG. 6 illustrates the schematic of one embodiment of a cylindrically fed holographic radial aperture antenna.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Embodiments disclosed herein include a systems architecture for a compute and storage platform that is localized within a communications terminal. In some embodiments, the communications terminal is a mobile communications terminal. The mobile communications terminal can be coupled to a vehicle or other mobile platform (e.g., mobile object). In some embodiments, the communications terminal includes a satellite antenna for use in a satellite communication system. Examples of such satellite antennas that may be used are described in further detail below.

Embodiments disclosed herein also include techniques for utilizing compute platforms embedded into a mobile antenna structure for providing access to clusters of software containers. By providing access to clusters of software containers, other parties (e.g., a manufacturer, etc.) can utilize ultra-portable applications with localized resources.

There are a number of innovations in the techniques described herein. For example, edge computing, or the extension of cloud-computing resources toward the tactical edge of the network, will continue to be widely implemented due to the reliability and performance gains of this mobile architecture. Most prior art implementations involve deploying stationary compute platforms to operational sites. In contrast, embodiments herein move the architecture to the remote user terminal and thus, onto a mobile platform. In this way, the benefits of computing at the edge can be realized wherever the equipped mobile device (e.g., a vehicle) operates.

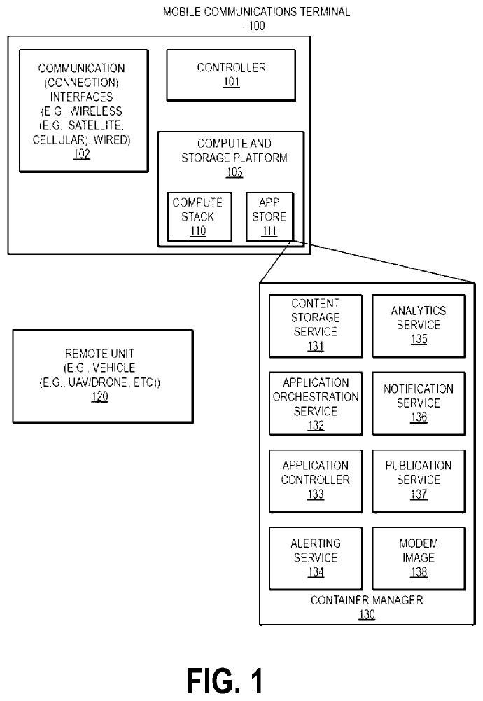

FIG. 1 is a block diagram of some embodiments of a mobile communications terminal. Referring to FIG. 1, mobile communications terminal 100 includes a controller 101, communication (and connection) interfaces 102, and an embedded compute and storage platform 103. Controller 101 controls operations of mobile communications terminal 100.

Communication interfaces 102 include communications hardware and software for communicating via wireless and/or wired connections. For example, in some embodiments, communication interfaces 102 comprise wireless functionality such as: a radio-frequency (RF) chain, a modem, a satellite antenna and other functionality for performing satellite communication; a cellular modem, an antenna and other functionality for performing cellular communication; a router, an antenna, and other functionality for performing WiFi communication. Other hardware and software for performing other types of wireless communication can also be included. Note that the wireless connections can be set up with other networks (e.g., wide-area networks (WANs), public networks, private networks, the Internet, etc.) for the purposes of communicating with users and remote units such as, for example, remote unit 120. In some embodiments, remote unit 120 comprises an unmanned aerial vehicle (UAV) (e.g., drone, etc.).

In some embodiments, communication interfaces 102 include interfaces for one or more wired connections. These wired connections can be to one or more of external sensors and IoT devices and/or their associated hubs, external local area networks (LANs), external radio systems, etc.

A compute (and storage) platform 103 is embedded in mobile communications terminal 100. In some embodiments, compute platform 103 operates as a platform at the edge of a network. In some embodiments, compute platform 103 includes an application store 111 to store software components such as, for example, applications and/or microservices. Compute platform 103 also includes a compute stack 110 for executing the software components.

In some embodiments, the software components in application store 111 include context-based software components. In some embodiments, compute stack 110 automatically executes one or more of these context-based software components based on each connection made to compute platform 103. That is, when a particular connection is made to compute platform 103 (and mobile communications terminal 100), then compute stack 110 automatically executes one or more of these context-based software components. For example, in some embodiments, compute platform 103 automatically requests one or more microservices for execution by compute stack 110 to provide data to a vehicle in response to the vehicle (e.g., a land-based vehicle (e.g., automobile, etc.), a maritime-based vehicle (e.g., a boat, a ship, etc.), an aerial vehicle (e.g., UAV, or drone, etc.) connecting to compute platform 103. Note also that in some embodiments, compute platform 103 automatically requests one or more microservices for execution by compute stack 110 to provide data to a mobile object (e.g., a flight capable asset (e.g., a base jumper in a wing suit wearing google glasses, etc.) in response to the mobile object connecting to compute platform 103.

In some other embodiments, compute platform 103 automatically requests one or more microservices for execution by compute stack 110 based on information acquired by the compute platform or one or more discrete inputs. For example, these discrete inputs can include an operator request for an application, an indication received by mobile communications terminal 100 that an event has occurred (e.g., a geofence has been crossed, a connection has been made, etc.), sensor data received via a connection to the compute platform that indicates location of an object.

### Portable Software Architecture

In some embodiments, compute platform 103 uses a containerized computing architecture and has a container manager 130 that is built onto the base operating system of compute platform 103. Container manager 130 creates, deploys and scales software containers. In some embodiments, the software containers include the full ecosystem for operating a given software component (e.g., a microservice, an application, etc.). In some embodiments, components can be rapidly deployed and off-loaded without impacting other services and applications already running in existing containers. This facilitates rapid development and deployment of simple software packages to support singular functions (e.g., a chat service, a mapping system, a call manager, etc.) rather than relying on expensive, complex, and fragile software ecosystems.

In some embodiments, application store 111 is established locally and utilizes intelligence (e.g., artificial intelligence (AI), machine learning (ML), dynamic policy settings, deep learning, etc.) to onboard applications and services as needed onto compute stack 110. In some embodiments, compute stack 110 comprises AI/ML accelerators. In some embodiments, as compute platform 103 utilizes a containerized software architecture, services and applications can be efficiently onboarded prior to being needed and then offloaded when no longer in demand. Many different services and applications will be continually available, while only a percentage will only ever actually be running in a container at any given time. This will enable the limited resources in compute stack 110 to efficiently process the applications and service of interest.

In some embodiments, application orchestration service 132, an intelligent microservice resident in container manager 130, dynamically determines compute resources available and will allocate resources accordingly on compute stack 103 to execute services and applications/microservices. Once application orchestration service 132 has allocated the resources on compute stack, the application or service is requested from application store 111 and the application or service is onboarded to compute stack 110.

In some embodiments, an application controller service 133 utilizes different types of controls such as, for example, artificial intelligence, a defined dynamic or static policy, or user request, to order the onboarding of a particular service or application from application orchestration service 132. The controls utilized can be intelligent in that they can be requested automatically given a learned set of circumstances. For example, application controller service 133 could learn that every time a UAV (e.g., drone) is connected to compute platform 103, users want to analyze video, so a video analysis service will be onboarded as soon as the drone is connected. Alternatively, application controller service 133 can automatically request an application or microservice be loaded in response to one or more discrete inputs. An example of a direct input can include position (e.g., when a vehicle crosses a geofence into an operational area, alerting service 134 is onboarded and executed by compute stack 110). Another example of a direct input can include operator can request a specific application.

In some embodiments, a subset of containers can be reserved for local device and network control. For example, one of the containers may feature a software defined network controller. Various modem images 138 can be stored for use by a software-defined modem based on the network hub architecture in use. In some other embodiments, using the containers, different data security can be implemented as part of the routing service and/or containers can be used to secure user data. A service can run that stores a data set of connectivity history both from the local platform and other platforms so that WAN behavior trends can be learned to further optimize the multi-WAN orchestration system.

In some embodiments, compute stack 110 also executes a content storage service 131 that collects content from the edge of the network via sensors, communications links, or other devices, and can publish that information to other nodes in the area. A separate publication service 137 can be included and used to publish information as well. This enables automated information sharing of information across similarly equipped platforms.

In some embodiment, content storage service 131 includes three components to complete the collection and dissemination of data. The first component is collection of the data. In some embodiments, the collection of data occurs automatically without user intervention. In some embodiments, compute platform 103 contains microservices and applications that are paired to various collection devices. A physical collection system (e.g., a drone video downlink, unmanned ground system, or a user wishing to share content) operates on a specific and potentially proprietary or classified air interface to connect the collector (e.g., the drone, sensor, or operator) with the collection point (e.g., the data system). In some embodiments, compute platform 103 has a configurable interface to connect various radios and controllers so that this connection can be facilitated. A corresponding service ingests and potentially normalize the data before moving it to a common data container. In some embodiments, the data in the container is loosely catalogued or categorized based on one or more preset parameters.

The second component is an automated analytics service 135 that serves to perform a deeper cataloguing of the data contained within the content. In some embodiments, analytics service 135 is an artificial intelligence (AI) component that performs different functions based on the type of content. Generally, however, analytics service 135 analyzes content in the container to find one or more of specific events of interest, pattern matching, mining for metadata, and other identification information. In some embodiments, analytics service 135 applies tags to the data sets including alerting hierarchies, time and data location tagging, and event-based tagging. In this way, compute platform 103 develops a high-level catalogue of the data that it currently holds and is collecting.

The third component is a notification service 136 that uses a policy set to send notifications or data elements to other users on the local networks (e.g., private LAN users, mesh network users) or users on the wide area networks (e.g., internet users). In one embodiment, these notifications are automatically generated in the event that certain categories or types of content are available in the local container, and the user or system that receives the notification has the option to view or download the content from the owning platform.

The three components described above operate as an automated collection, analytic, and a distribution system for content collected or generated on the mobile edge of the network. In some embodiments, there is another element that involves a subscription to data available on the network so that all content collectors can automatically disseminate content of interest to users that subscribe. The dissemination can be performed by publication service 137. Subscriptions can take the place of alert categories, data or event tags, or meta data tags such as location. In one embodiment, when content is collected at any node on the network that matches the criteria that the subscriber has defined, the content or a notification of available content is automatically pushed to that user based on the policy settings. Thus, in some embodiments, the systems architecture described herein includes the software architecture for supporting a local area publication and subscription method for the intelligent distribution of information.

In some embodiments, a master node is used. When more than one mobile edge compute node joins to form a group via local network interface, one becomes the network master and holds the database of record for all content subscriptions and other network settings while all other nodes on the network can be assigned a priority and maintain a local representation of this database. In the event that the network master leaves the network, a secondary network master takes over based on assigned priority and so on in a manner well-known in the art.

In some embodiments, when a node with a mobile edge compute platform joins an existing group of nodes, it requests all current subscriptions on the network, and the network master then shares all subscriptions so that when data is collected at any node, a service identifies any active network users who may have a subscription to that particular content set. If so, then the collector pushes the content or a notification to the user.

Finally, in some embodiments, any information collected at compute platform 103 can be automatically synchronized with fixed edge platforms and the cloud systems as appropriate so that data and information is always current and relevant without increasing the burden to the operator.

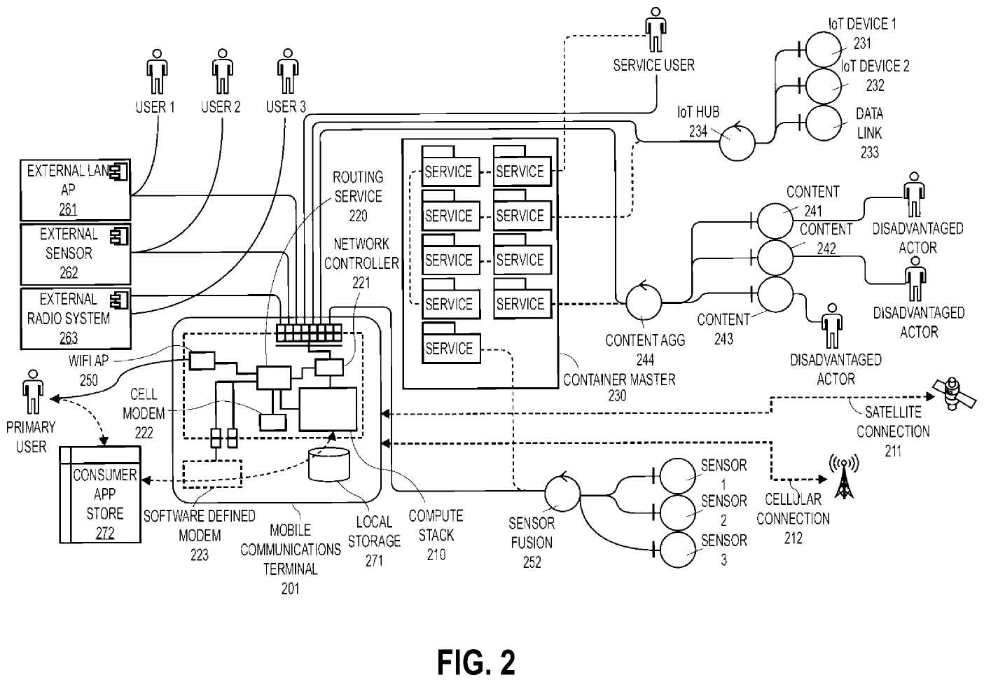

FIG. 2 illustrates some other embodiments of a mobile communications terminal environment. Referring to FIG. 2, mobile communications terminal 201 includes an integrated compute and storage platform with a number of components and includes a number of services to facilitate performing communications. In some embodiments, these services include a routing service 220 that controls the routing for terminal 201, including the routing of data and information through communication interfaces, such as through wireless or wired connections. Routing service 220 is coupled to a network controller 221 that controls network access and connects multiple connections to terminal 201 via wireless connections (e.g., satellite connections such as satellite connection 211, cellular connections such as cellular connection 212, WiFi connections, etc.), and wired connections. In some embodiments, routing service 220 is also coupled to a cellular modem 222 which provides access to cellular networks such as, for example, those associated with evolved packet cores (EPCs).

In some embodiments, a number of wired connections to terminal 201 can exist. For example, terminal 201 is connected to external local area network (LAN) 261, external sensor 262, and external radio system 263, a service user, an Internet of Things (IoT) hub 234, content aggregator 244, and sensor fusion (sensor data combiner) 252 via wired connections. IoT hub 234 is coupled between terminal 201 and IoT devices 231 and 232 and data link 233 for exchanging information. Content aggregator 244 is coupled to and aggregates content from content sources 241-243 and provides the content to terminal 201. Sensor fusion 252 combines sensor data from sensors, such as for example, sensors 1-3 and provides the sensor data to terminal 201.

In some embodiments, terminal 201 incudes a compute stack 210 performing computing operations, including those for executing services (e.g., microservices) such as services of container master (manager) 230. These services are stored in local storage 271 or container application storage 272. In some embodiments, compute stack 210 includes one or more processors that execute code to perform functions associated with terminal 201. The code can be part of a container, container cluster, application store, container manager, etc. In some embodiments, routing service 220 is also coupled to software defined modem 223.

Note that some of the services are paired with users and/or devices. For example, one or more of sensors 251, IoT devices 231, 232, data link 233, content sources 241-243 may be paired with one or more microservices in container master 230. These pairings are shown as dashed lines in FIG. 2.

Terminal 201 also includes local storage 271 that may store one or more containers. These containers may include applications from consumer application store 272 and are accessed by a user (e.g., primary user of user terminal 201) or automatically by the compute platform in response to an event (e.g., a connection to the platform) or a direct input(s) to the platform. A user may have access to terminal 201 by, for example, a WiFi AP application 250, which is coupled to routing service 220.

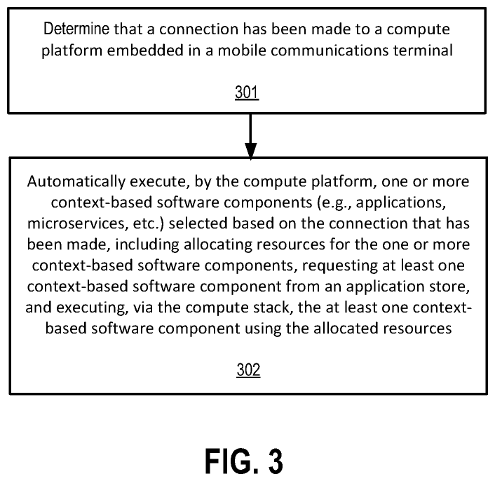

FIG. 3 is a flow diagram of some embodiments of a process for processing data with a compute and storage platform on a mobile communications terminal. The process is performed by processing logic that comprises hardware (e.g., circuitry, dedicated logic, etc.), software (e.g., software running on a chip(s) or processor(s), etc.), firmware, or a combination of the three. In some embodiments, the processing logic is part of a satellite terminal (e.g., mobile communications terminal 101, 201).

Referring to FIG. 3, the process begins by determining that a connection has been made to a compute platform embedded in a mobile communications terminal (processing block 301). Based on the connection that has been made, the compute platform automatically executes one or more context-based software components (e.g., applications, microservices, etc.) selected based on the connection that has been made (processing block 302). In some embodiments, the compute platform executes the software components using a compute stack of the mobile communications terminal.

In some embodiments, automatically executing one or more context-based software components comprises allocating resources for the one or more context-based software components, requesting at least one context-based software component from an application store, and executing, via the compute stack, the at least one context-based software component using the allocated resources. In some embodiments, the resource allocation is performed by an application orchestration service executing on the compute platform.

In some embodiments, requesting at least one context-based software component from an application store is based on learned information acquired by the compute platform or information received by the compute platform one or more discrete inputs. In some embodiments, the one or more discrete inputs comprises an operator request for an application. In some embodiments, the one or more discrete inputs comprises an indication that an event has occurred. In some embodiments, the one or more discrete inputs comprises sensor data received via a connection to the compute platform that indicates location of an object.

In some embodiments, the mobile communications terminal with the mobile edge computing can automatically set up different microservices to provide an unmanned aerial vehicle (UAV) (e.g., drone) the kind of data that it needs. In some embodiments, the application controller service of the mobile communications terminal knows that every time a UAV (e.g., drone) is connected to the compute platform, users of the UAV want to analyze video, and causes a video analysis service to be onboarded to the compute stack as soon as the drone is connected. That is, once the UAV is connected to the mobile communications terminal, the compute platform triggers performance of a video analysis service to analyze some video. In some other embodiments, other content is analyzed (e.g., audio, etc.). The video or other content can come from the UAV or be provided from another source (e.g., a sensor).

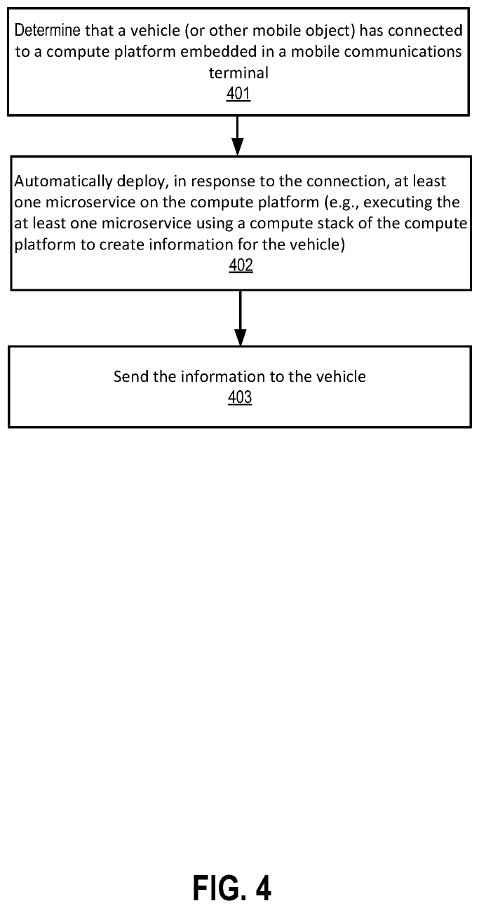

FIG. 4 is a flow diagram of some embodiments of a process for executing microservices responsive to a connection to a mobile communications terminal. The process is performed by processing logic that comprises hardware (e.g., circuitry, dedicated logic, etc.), software (e.g., software running on a chip(s) or processor(s), etc.), firmware, or a combination of the three. In some embodiments, the processing logic is part of a satellite terminal (e.g., mobile communications terminal 101, 201).

Referring to FIG. 4, the process begins by determining that a vehicle (e.g., an unmanned aerial vehicle (UAV)) has connected to a compute platform embedded in a mobile communications terminal (processing block 401). In some embodiments in which the vehicle is a UAV, this determination is made by first having the connection build the communication stack between the modems of the mobile communications terminal and the UAV and then having the system of the UAV authenticate with the mobile communication platform of the mobile communications terminal. At this point, traffic can flow between the two systems and from microservices running on the mobile communications terminal.

In response to the connection, processing logic automatically deploys at least one microservice on the compute platform (processing block 402). In some embodiments, this deployment includes executing the at least one microservice using a compute stack of the compute platform to create information for the vehicle. In some embodiments, one microservice of the at least one microservices analyzes content to create results that included the information. In some embodiments, the content is received by the mobile communications terminal. In some embodiments, the content is received from the vehicle over a communication interface of mobile communications terminal. In some embodiments, the content is received from a sensor paired with a collection microservice executed by the compute platform.

Processing logic then sends the information to the vehicle (processing block 403).

Note that the data flow of FIG. 4 is not limited to certain types of vehicles and can be performed for other types of vehicles or other types of mobile objects/platforms, including those described above.

Furthermore, the processes of FIGS. 3 and 4, as well as processes of other embodiments described herein can be modified. For example, in some embodiments, the process (e.g., processing block 401 of FIG. 4) is modified to determine that a user with certain credentials, as opposed to a vehicle, has connected to a compute platform embedded in a mobile communications terminal. This causes the automated execution of software components (e.g., a microservice, an application, etc.) by the compute platform.

In some other embodiments, the mobile communications terminal has a modular hardware design. Such a design can add extra compute/storage to the mobile communications terminal. Also, in some embodiments, the containers can be turned off or one based on whether there are enough compute power or resources to complete their associate operations and tasks.

In some other embodiments, the storage (e.g., local storage 271 of FIG. 2, consumer application storage 272 of FIG. 2 if maintained on the mobile user terminal, etc.) is removable from the terminal. In some embodiments, if a first mobile communications terminal is disabled, this storage with the containers, software containers, and/or services contained therein can be extracted and loaded into a second mobile communications terminal, and the second mobile communications is ready to operate.

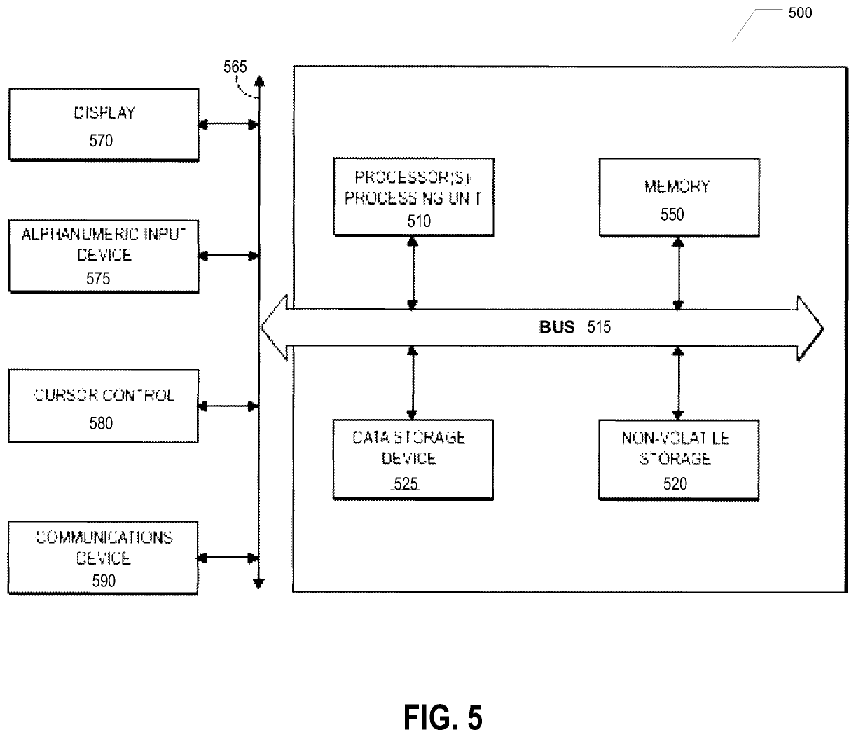

FIG. 5 is one embodiment of a computing device that may be part of the mobile communications terminal to support the operations discussed herein, including the compute stack. It will be apparent to those of ordinary skill in the art, however, that other alternative computing devices of various system architectures may also be used.

The computing device illustrated in FIG. 5 includes a bus or other internal communication means 515 for communicating information, and one or more processors 510 coupled to the bus 515 for processing information. The computing device further comprises a random-access memory (RAM) or other volatile storage device 550 (referred to as memory), coupled to bus 515 for storing information and instructions to be executed by processor 510. Main memory 550 also may be used for storing temporary variables or other intermediate information during execution of instructions by processor(s) 510. The computing device also comprises a read only memory (ROM) and/or non-volatile (static) storage device 520 coupled to bus 515 for storing static information and instructions for processor 510, and a data storage device 525 such as a magnetic disk or optical disk and its corresponding disk drive. Data storage device 525 is coupled to bus 515 for storing information and instructions.

Another device, which may optionally be coupled to computing device 500, is a communication device 590 for accessing other nodes of a distributed system via a network (e.g., a WAN network). The communication device 590 may include any of a number of commercially available networking peripheral devices such as those used for coupling to an Ethernet, token ring, Internet, or wide area network. The communication device 590 may further be a null-modem connection, or any other mechanism that provides connectivity between the computing device 500 and the outside world. Note that any or all of the components of this system illustrated in FIG. 5 and associated hardware may be used in various embodiments as discussed herein.

In some embodiments, processor(s) 510 executes instructions to perform any of the operations described above including, but not limited to, the services described above with respect to the communications terminal, including the compute stack, containers and the software components (e.g., applications, microservices, etc.).

It will be appreciated by those of ordinary skill in the art that any configuration of the computing device may be used for various purposes according to the particular implementation. The control logic or software implementing the described embodiments can be stored in main memory 550, data storage device 525, or other storage medium locally or remotely accessible to processor 510.

In some embodiments, the computing device may further be coupled to a display device 570, such as a light emitting diode (LED) display or a liquid crystal display (LCD) coupled to bus 515 through bus 565 for displaying information to a user. An alphanumeric input device 575, including alphanumeric and other keys, may also be coupled to bus 515 through bus 565 for communicating information and command selections to processor 510. An additional user input device is cursor control device 580, such as a touchpad, mouse, a trackball, stylus, or cursor direction keys coupled to bus 515 through bus 565 for communicating direction information and command selections to processor 510, and for controlling cursor movement on display device 570.

It will be apparent to those of ordinary skill in the art that the computing, method, and process described herein can be implemented as software stored in main memory 550 or non-volatile memory 520 and executed by processor 510. This control logic or software may also be resident on an article of manufacture comprising a computer readable medium having computer readable program code embodied therein and being readable by the data storage device 525 and for causing the processor 510 to operate in accordance with the methods and teachings herein.

The embodiments discussed herein may also be embodied in a special purpose appliance including a subset of the computer hardware components described above. For example, the appliance may include processor 510, data storage device 525, bus 515, and memory 550, and only rudimentary communications mechanisms that permit the user to communicate in a basic manner with the device. In general, the more special-purpose the device is, the fewer of the elements need to be present for the device to function.

Embodiments described herein include one or more of the following advantages: improves user experience though locally stored, more quickly accessed information; improves user experience for information sharing locally amongst connected devices; improves call times for information that is fully or partially stored locally; reduces operating cost for mobile satellite communications; reduces operating cost for mobile cellular communications; reduces total cost of ownership for mobile satellite communications; reduces total cost of ownership for mobile cellular communications; improves data robustness for satellite communications; improves data robustness for cellular communications; increases value of data collected/transported; and increases value of data via local processing, tagging, compression, mining, or other advanced edge processing capabilities.

Embodiments described herein have one or more of a number of benefits that overcome one or more of the following: the cost of moving data from the edge to the cloud for processing is too high, the latency of moving data from the edge to the cloud for processing is too long, the value of the data captured at the edge may not be worth moving to the cloud and processing locally to optimize value will ensure the cost is not too high, and line of sight (satellite) communications do not always have a data session available. Storing data at the edge to buffer communication with the network/cloud will improve data robustness.

Thus, embodiments described herein are ruggedized, mobile, variable network adaptable, compute and storage system.

### Examples of Antenna Embodiments

The techniques described above may be used with flat panel satellite antennas. Embodiments of such flat panel antennas are disclosed. The flat panel antennas include one or more arrays of antenna elements on an antenna aperture. In some embodiments, the antenna aperture is a metasurface antenna aperture, such as, for example, the antenna apertures described below. In some embodiments, the antenna elements comprise diodes and varactors such as, for example, described above and described in U.S. Patent Application Publication No. 20210050671, entitled “Metasurface Antennas Manufactured with Mass Transfer Technologies,” published Feb. 18, 2021. In other embodiments, the antenna elements comprises LC-based antenna elements, such as, for example, those disclosed in U.S. Pat. No. 9,887,456, entitled “Dynamic polarization and coupling control from a steerable cylindrically fed holographic antenna”, issued Feb. 6, 2018, or other RF radiating antenna elements. In some embodiments, the flat panel antenna is a cylindrically fed antenna that includes matrix drive circuitry to uniquely address and drive each of the antenna elements that are not placed in rows and columns. In some embodiments, the elements are placed in rings.

In some embodiments, the antenna aperture having the one or more arrays of antenna elements is comprised of multiple segments coupled together. When coupled together, the combination of the segments form closed concentric rings of antenna elements. In some embodiments, the concentric rings are concentric with respect to the antenna feed.

In some embodiments, the flat panel antenna is part of a metamaterial antenna system. Embodiments of a metamaterial antenna system for communications satellite earth stations are described. In some embodiments, the antenna system is a component or subsystem of a satellite earth station (ES) operating on a mobile platform (e.g., aeronautical, maritime, land, etc.) that operates using either Ka-band frequencies or Ku-band frequencies for civil commercial satellite communications. Note that embodiments of the antenna system also can be used in earth stations that are not on mobile platforms (e.g., fixed or transportable earth stations).

In some embodiments, the antenna system uses surface scattering metamaterial technology to form and steer transmit and receive beams through separate antennas.

In some embodiments, the antenna system is comprised of three functional subsystems: (1) a wave guiding structure consisting of a cylindrical wave feed architecture; (2) an array of wave scattering metamaterial unit cells that are part of antenna elements; and (3) a control structure to command formation of an adjustable radiation field (beam) from the metamaterial scattering elements using holographic principles.

### Antenna Elements

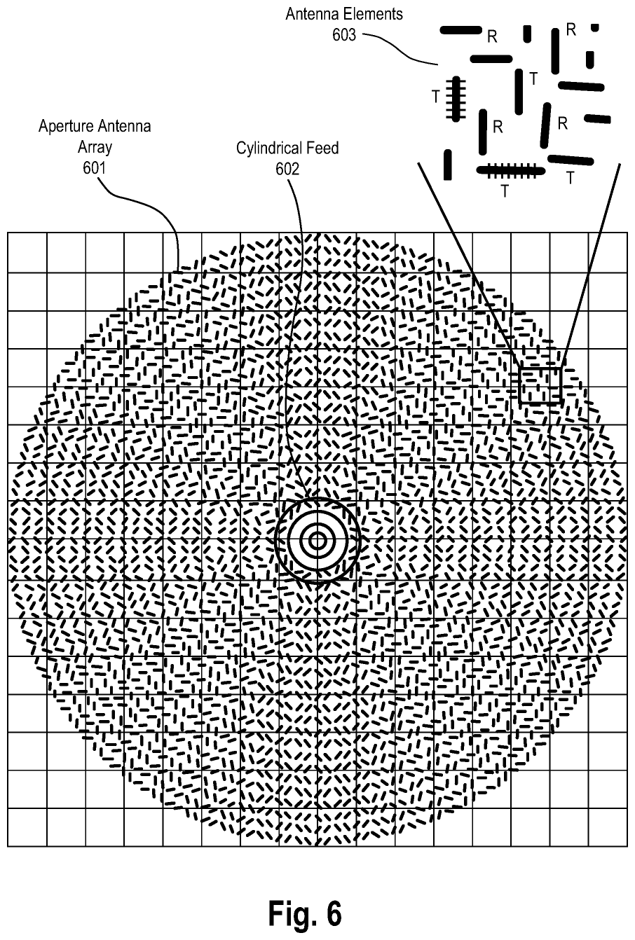

FIG. 6 illustrates the schematic of one embodiment of a cylindrically fed holographic radial aperture antenna. Referring to FIG. 6, the antenna aperture has one or more arrays 601 of antenna elements 603 that are placed in concentric rings around an input feed 602 of the cylindrically fed antenna. In some embodiments, antenna elements 603 are radio frequency (RF) resonators that radiate RF energy. In some embodiments, antenna elements 603 comprise both Rx and Tx irises that are interleaved and distributed on the whole surface of the antenna aperture. Examples of such antenna elements are described in greater detail below. Note that the RF resonators described herein may be used in antennas that do not include a cylindrical feed.

In some embodiments, the antenna includes a coaxial feed that is used to provide a cylindrical wave feed via input feed 602. In some embodiments, the cylindrical wave feed architecture feeds the antenna from a central point with an excitation that spreads outward in a cylindrical manner from the feed point. That is, a cylindrically fed antenna creates an outward travelling concentric feed wave. Even so, the shape of the cylindrical feed antenna around the cylindrical feed can be circular, square or any shape. In another embodiment, a cylindrically fed antenna creates an inward travelling feed wave. In such a case, the feed wave most naturally comes from a circular structure.

In some embodiments, antenna elements 603 comprise irises and the aperture antenna of FIG. 6 is used to generate a main beam shaped by using excitation from a cylindrical feed wave for radiating irises through tunable liquid crystal (LC) material. In some embodiments, the antenna can be excited to radiate a horizontally or vertically polarized electric field at desired scan angles.

In some embodiments, the antenna elements comprise a group of patch antennas. This group of patch antennas comprises an array of scattering metamaterial elements. In some embodiments, each scattering element in the antenna system is part of a unit cell that consists of a lower conductor, a dielectric substrate and an upper conductor that embeds a complementary electric inductive-capacitive resonator (“complementary electric LC” or “CELC”) that is etched in or deposited onto the upper conductor. As would be understood by those skilled in the art, LC in the context of CELC refers to inductance-capacitance, as opposed to liquid crystal.

In some embodiments, a liquid crystal (LC) is disposed in the gap around the scattering element. This LC is driven by the direct drive embodiments described above. In some embodiments, liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, in some embodiments, the liquid crystal integrates an on/off switch for the transmission of energy from the guided wave to the CELC. When switched on, the CELC emits an electromagnetic wave like an electrically small dipole antenna. Note that the teachings herein are not limited to having a liquid crystal that operates in a binary fashion with respect to energy transmission.

In some embodiments, the feed geometry of this antenna system allows the antenna elements to be positioned at forty-five-degree (45°) angles to the vector of the wave in the wave feed. Note that other positions may be used (e.g., at 40° angles). This position of the elements enables control of the free space wave received by or transmitted/radiated from the elements. In some embodiments, the antenna elements are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In some embodiments, the two sets of elements are perpendicular to each other and simultaneously have equal amplitude excitation if controlled to the same tuning state. Rotating them +/−45 degrees relative to the feed wave excitation achieves both desired features at once. Rotating one set 0 degrees and the other 90 degrees would achieve the perpendicular goal, but not the equal amplitude excitation goal. Note that 0 and 90 degrees may be used to achieve isolation when feeding the array of antenna elements in a single structure from two sides.

The amount of radiated power from each unit cell is controlled by applying a voltage to the patch (potential across the LC channel) using a controller. Traces to each patch are used to provide the voltage to the patch antenna. The voltage is used to tune or detune the capacitance and thus the resonance frequency of individual elements to effectuate beam forming. The voltage required is dependent on the liquid crystal mixture being used. The voltage tuning characteristic of liquid crystal mixtures is mainly described by a threshold voltage at which the liquid crystal starts to be affected by the voltage and the saturation voltage, above which an increase of the voltage does not cause major tuning in liquid crystal. These two characteristic parameters can change for different liquid crystal mixtures.

In some other embodiments, antenna elements 603 comprise irises and diodes or varactors and the aperture antenna of FIG. 6 is used to generate a main beam shaped by using excitation from a cylindrical feed wave for radiating irises.

In some embodiments, as discussed above, a matrix drive is used to apply voltage to the patches in order to drive each cell separately from all the other cells without having a separate connection for each cell (direct drive). Because of the high density of elements, the matrix drive is an efficient way to address each cell individually.

In some embodiments, the control structure for the antenna system has 2 main components: the antenna array controller, which includes drive electronics, for the antenna system, is below the wave scattering structure, while the matrix drive switching array is interspersed throughout the radiating RF array in such a way as to not interfere with the radiation. In some embodiments, the drive electronics for the antenna system comprise commercial off-the shelf LCD controls used in commercial television appliances that adjust the bias voltage for each scattering element by adjusting the amplitude or duty cycle of an AC bias signal to that element.

In some embodiments, the antenna array controller also contains a microprocessor executing the software. The control structure may also incorporate sensors (e.g., a GPS receiver, a three-axis compass, a 3-axis accelerometer, 3-axis gyro, 3-axis magnetometer, etc.) to provide location and orientation information to the processor. The location and orientation information may be provided to the processor by other systems in the earth station and/or may not be part of the antenna system.

More specifically, the antenna array controller controls which elements are turned off and those elements turned on and at which phase and amplitude level at the frequency of operation. The elements are selectively detuned for frequency operation by voltage application.

For transmission, a controller supplies an array of voltage signals to the RF patches to create a modulation, or control pattern. The control pattern causes the elements to be turned to different states. In some embodiments, multistate control is used in which various elements are turned on and off to varying levels, further approximating a sinusoidal control pattern, as opposed to a square wave (i.e., a sinusoid gray shade modulation pattern). In some embodiments, some elements radiate more strongly than others, rather than some elements radiate and some do not. Variable radiation is achieved by applying specific voltage levels, which adjusts the liquid crystal permittivity to varying amounts, thereby detuning elements variably and causing some elements to radiate more than others.

The generation of a focused beam by the metamaterial array of elements can be explained by the phenomenon of constructive and destructive interference. Individual electromagnetic waves sum up (constructive interference) if they have the same phase when they meet in free space and waves cancel each other (destructive interference) if they are in opposite phase when they meet in free space. If the slots in a slotted antenna are positioned so that each successive slot is positioned at a different distance from the excitation point of the guided wave, the scattered wave from that element will have a different phase than the scattered wave of the previous slot. If the slots are spaced one quarter of a guided wavelength apart, each slot will scatter a wave with a one fourth phase delay from the previous slot.

Using the array, the number of patterns of constructive and destructive interference that can be produced can be increased so that beams can be pointed theoretically in any direction plus or minus ninety degrees (90°) from the bore sight of the antenna array, using the principles of holography. Thus, by controlling which metamaterial unit cells are turned on or off (i.e., by changing the pattern of which cells are turned on and which cells are turned off), a different pattern of constructive and destructive interference can be produced, and the antenna can change the direction of the main beam. The time required to turn the unit cells on and off dictates the speed at which the beam can be switched from one location to another location.

In some embodiments, the antenna system produces one steerable beam for the uplink antenna and one steerable beam for the downlink antenna. In some embodiments, the antenna system uses metamaterial technology to receive beams and to decode signals from the satellite and to form transmit beams that are directed toward the satellite. In some embodiments, the antenna systems are analog systems, in contrast to antenna systems that employ digital signal processing to electrically form and steer beams (such as phased array antennas). In some embodiments, the antenna system is considered a “surface” antenna that is planar and relatively low profile, especially when compared to conventional satellite dish receivers.

There are a number of example embodiments described herein.

Example 1 is a mobile communications terminal comprising: one or more communication interfaces for connecting to the terminal; and a compute platform to request and execute one or more context-based software components automatically based on each connection made to the platform.

Example 2 is the mobile communications terminal of example 1 that may optionally include that the one or more software components comprise one or more microservices or applications.

Example 3 is the mobile communications terminal of example 1 that may optionally include that the compute platform comprises a compute stack and automatically requests one or more microservices for execution by the compute stack to provide data to a mobile object in response to the vehicle connecting to the compute platform.

Example 4 is the mobile communications terminal of example 3 that may optionally include that the mobile object is an unmanned aerial vehicle.

Example 5 is the mobile communications terminal of example 1 that may optionally include that the compute platform comprises a compute stack and automatically requests the one or more software components for execution by the compute stack based on information acquired by the compute platform or one or more discrete inputs.

Example 6 is the mobile communications terminal of example 5 that may optionally include that the one or more discrete inputs comprises an operator request for an application.

Example 7 is the mobile communications terminal of example 5 that may optionally include that the one or more discrete inputs comprises an indication that an event has occurred.

Example 8 is the mobile communications terminal of example 5 that may optionally include that the one or more discrete inputs comprises sensor data received via a connection to the compute platform that indicates location of an object.

Example 9 is the mobile communications terminal of example 1 that may optionally include that the compute platform comprises a compute stack that executes a content storage service for automatically collecting, analyzing and distributing content collected or generated on the compute platform, wherein individual ones of a portion of the one or more microservices and applications are paired to collection devices for collecting the content and providing the content through connections via configurable interfaces connectable to one or more radios and controllers.

Example 10 is a method comprising: determining that a connection has been made to a compute platform embedded in a mobile communications terminal; automatically executing, using a compute stack of the compute platform, one or more context-based software components selected based on the connection that has been made, wherein automatically executing one or more context-based software components comprises allocating, by an application orchestration service of the compute platform, resources for the one or more context-based software components, requesting at least one context-based software component from an application store, and executing, via the compute stack, the at least one context-based software component using the allocated resources.

Example 11 is the method of example 10 that may optionally include that requesting at least one context-based software component from an application store is based on learned information acquired by the compute platform or information received by the compute platform from one or more discrete inputs.

Example 12 is the method of example 11 that may optionally include that the one or more discrete inputs comprises an operator request for an application.

Example 13 is the method of example 11 that may optionally include that the one or more discrete inputs comprises an indication that an event has occurred.

Example 14 is the method of example 11 that may optionally include that the one or more discrete inputs comprises sensor data received via a connection to the compute platform that indicates location of an object.

Example 15 is a method comprising: determining that a vehicle has connected to a compute platform embedded in a mobile communications terminal; automatically deploying, on the compute platform, at least one microservice in response to determining the vehicle has connected to the compute platform, including executing the at least one microservice using a compute stack of the compute platform to create information for the vehicle; and sending the information to the vehicle.

Example 16 is the method of example 15 that may optionally include that one microservice of the at least one microservices analyzes content to create results that are part of the information.

Example 17 is the method of example 16 that may optionally include that the content is received by the mobile communications terminal.

Example 18 is the method of example 17 that may optionally include that the content is received from the vehicle over a communication interface of mobile communications terminal.

Example 19 is the method of example 17 that may optionally include that the content is received from a sensor paired with a collection microservice executed by the compute platform.

Example 20 is the method of example 15 that may optionally include that the vehicle comprises a unmanned aerial vehicle (UAV).

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A mobile communications terminal comprising:
one or more communication interfaces for connecting to the terminal; and
a compute platform to request and execute one or more context-based software components automatically based on each connection made to the platform.

2. The mobile communications terminal of claim 1 wherein the one or more software components comprise one or more microservices or applications.

3. The mobile communications terminal of claim 1 wherein the compute platform comprises a compute stack and automatically requests one or more microservices for execution by the compute stack to provide data to a mobile object in response to the mobile object connecting to the compute platform.

4. The mobile communications terminal of claim 3 wherein the mobile object is an unmanned aerial vehicle.

5. The mobile communications terminal of claim 1 wherein the compute platform comprises a compute stack and automatically requests the one or more software components for execution by the compute stack based on information acquired by the compute platform or one or more discrete inputs.

6. The mobile communications terminal of claim 5 wherein the one or more discrete inputs comprises an operator request for an application.

7. The mobile communications terminal of claim 5 wherein the one or more discrete inputs comprises an indication that an event has occurred.

8. The mobile communications terminal of claim 5 wherein the one or more discrete inputs comprises sensor data received via a connection to the compute platform that indicates location of an object.

9. The mobile communications terminal of claim 1 wherein the compute platform comprises a compute stack that executes a content storage service for automatically collecting, analyzing and distributing content collected or generated on the compute platform, wherein individual ones of a portion of the one or more microservices and applications are paired to collection devices for collecting the content and providing the content through connections via configurable interfaces connectable to one or more radios and controllers.

10. The mobile communications terminal of claim 1 wherein the compute platform comprises a compute stack and automatically requests one or more microservices for execution by the compute stack to provide data to a mobile object in response to a user with certain credentials connecting to the compute platform.

11. A method comprising:
determining that a connection has been made to a compute platform embedded in a mobile communications terminal;
automatically executing, using a compute stack of the compute platform, one or more context-based software components selected based on the connection that has been made, wherein automatically executing one or more context-based software components comprises
allocating, by an application orchestration service of the compute platform, resources for the one or more context-based software components,
requesting at least one context-based software component from an application store, and
executing, via the compute stack, the at least one context-based software component using the allocated resources.

12. The method of claim 11 wherein requesting at least one context-based software component from an application store is based on learned information acquired by the compute platform or information received by the compute platform from one or more discrete inputs.

13. The method of claim 12 wherein the one or more discrete inputs comprises an operator request for an application.

14. The method of claim 12 wherein the one or more discrete inputs comprises an indication that an event has occurred.

15. A method comprising:
determining that a vehicle has connected to a compute platform embedded in a mobile communications terminal;
automatically deploying, on the compute platform, at least one microservice in response to determining the vehicle has connected to the compute platform, including executing the at least one microservice using a compute stack of the compute platform to create information for the vehicle; and
sending the information to the vehicle.

16. The method of claim 15 wherein one microservice of the at least one microservices analyzes content to create results that are part of the information.

17. The method of claim 16 wherein the content is received by the mobile communications terminal.

18. The method of claim 17 wherein the content is received from the vehicle over a communication interface of mobile communications terminal.

19. The method of claim 17 wherein the content is received from a sensor paired with a collection microservice executed by the compute platform.

20. The method of claim 15 wherein the vehicle comprises an unmanned aerial vehicle (UAV).
